(19) United States
(12) Patent Application Publication
(10) Pub. No.: US 2006/0143384 A1
(43) Pub. Date: Jun. 29, 2006

(54) System and method for non-uniform cache in a multi-core processor

(76) Inventors: Christopher J. Hughes, San Jose, CA (US); James M. Tuck III, Savoy, IL (US); Victor W. Lee, San Jose, CA (US); Yen-Kuang Chen, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,925

(22) Filed: Dec. 27, 2004

(51) Int. Cl. G06F 12/00

(52) U.S. Cl. 711/130

(57) ABSTRACT

A system and method for the design and operation of a distributed shared cache in a multi-core processor is disclosed. In one embodiment, the shared cache may be distributed among multiple cache molecules. Each of the cache molecules may be closest, in terms of access latency time, to one of the processor cores. In one embodiment, a cache line brought in from memory may initially be placed into a cache molecule that is not closest to a requesting processor core. When the requesting processor core makes repeated accesses to that cache line, it may be moved either between cache molecules or within a cache molecule. Due to the ability to move the cache lines within the cache, in various embodiments special search methods may be used to locate a particular cache line.

The present invention relates generally to microprocessors, and more specifically to microprocessors that may include multiple processor cores.

### BACKGROUND

Modern microprocessors may include two or more processor cores on a single semiconductor device. Such microprocessors may be called multi-core processors. The use of these multiple cores may improve performance beyond that permitted by using a single core. However, traditional shared cache architectures may not be especially suited to support the design of multi-core processors. Here “shared” may mean that each of the cores may access cache lines within the cache. Traditional architecture shared caches may use one common structure to store the cache lines. Due to layout constraints and other factors, the access latency time from such a cache to one core may differ from the access latency to another core. Generally this situation may be compensated for by adopting a “worst case” design rule for access latency time from the varying cores. Such a policy may increase the average access latency time for all of the cores.

It would be possible to partition the cache and locate the partitions throughout the semiconductor device containing the various processor cores. However, this may not by itself significantly decrease the average access latency time for all of the cores. A particular core may have improved access latency for cache partitions physically located near the requesting core. However, that requesting core may also access cache lines contained in partitions physically located at a distance from the requesting core on the semiconductor device. The access latency times for such cache lines may be substantially greater than those from the cache partitions located physically close to the requesting core.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a diagram of cache molecules on a ring interconnect, according to one embodiment of the present disclosure.

FIG. 2 is a diagram of a cache molecule, according to one embodiment of the present disclosure.

FIG. 3 is a diagram of cache tiles in a cache chain, according to one embodiment of the present disclosure.

FIG. 4 is a diagram of searching for a cache line, according to one embodiment of the present disclosure.

FIG. 5 is a diagram of a non-uniform cache architecture collection service, according to another embodiment of the present disclosure.

FIG. 6A is a diagram of a lookup status holding register, according to another embodiment of the present disclosure.

FIG. 6B is a diagram of a lookup status holding register entry, according to another embodiment of the present disclosure.

FIG. 7 is a flowchart of a method for searching for a cache line, according to another embodiment of the present disclosure.

FIG. 8 is a diagram of a cache molecule with breadcrumb table, according to another embodiment of the present disclosure.

FIG. 9A is a schematic diagram of a system with processors with multiple cores and cache molecules, according to an embodiment of the present disclosure.

FIG. 9B is a schematic diagram of a system with processors with multiple cores and cache molecules, according to another embodiment of the present disclosure.

### DETAILED DESCRIPTION

The following description includes techniques for design and operation of non-uniform shared caches in a multi-core processor. In the following description, numerous specific details such as logic implementations, software module allocation, bus and other interface signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments, the invention is disclosed in the environment of an Itanium® Processor Family compatible processor (such as those produced by Intel® Corporation) and the associated system and processor firmware. However, the invention may be practiced with other kinds of processor systems, such as with a Pentium® compatible processor system (such as those produced by Intel® Corporation), an X-Scale® family compatible processor, or any of a wide variety of different general-purpose processors from any of the processor architectures of other vendors or designers. Additionally, some embodiments may include or may be special purpose processors, such as graphics, network, image, communications, or any other known or otherwise available type of processor in connection with its firmware.

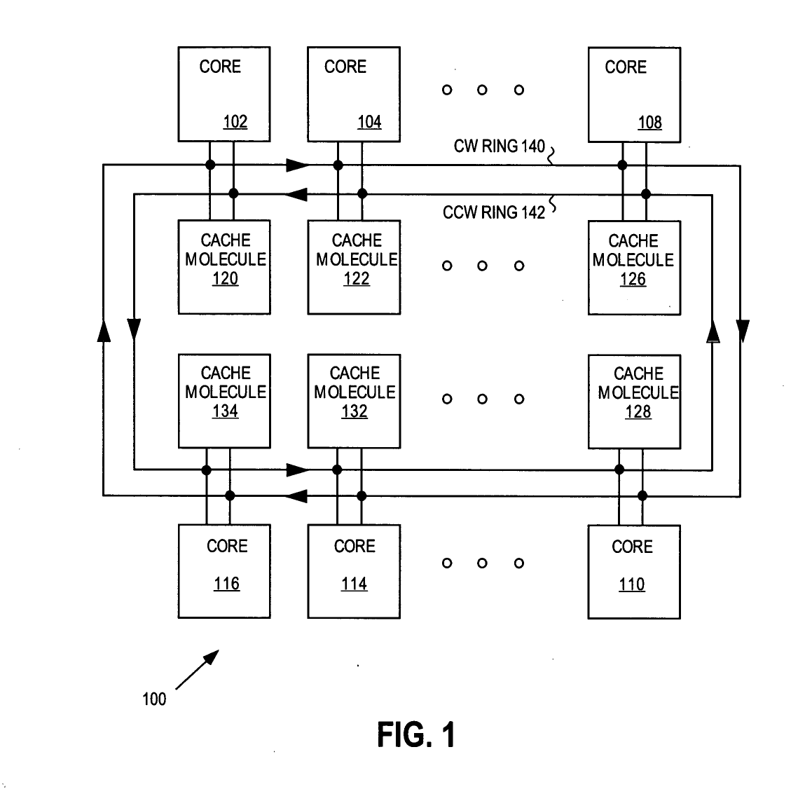

Referring now to FIG. 1, a diagram of cache molecules on a ring interconnect is shown, according to one embodiment of the present disclosure. Processor 100 may include several processor cores 102-116 and cache molecules 120-134. In varying embodiments the processor cores 102-116 may be similar copies of a common core design, or they may vary substantially in processing power. The cache molecules 120-134 collectively may be functionally equivalent to a traditional unitary cache. In one embodiment, they may form a level two (L2) cache, with a level one (L1) cache being located within cores 102-116. In other embodiments, the cache molecules may be located at differing levels within an overall cache hierarchy.

The cores 102-116 and cache molecules 120-134 are shown connected with a redundant bi-directional ring interconnect, consisting of clockwise (CW) ring 140 and counter-clockwise (CCW) ring 142. Each portion of the ring may convey any data among the modules shown. Each core of cores 102-116 is shown being paired with a cache molecule of cache molecules 120-134. The paring is to logically associate a core with the “closest” cache molecule in terms of low access latency. For example, core 104 may have the lowest access latency when accessing a cache line in cache molecule 122, and would have an increased access latency when accessing other cache molecules. In other embodiments, two or more cores could share a single cache molecule, or there may be two or more cache molecules associated with a particular core.

A metric of “distance” may be used to describe a latency ordering of cache molecules with respect to a particular core. In some embodiments, this distance may correlate to a physical distance between the core and the cache molecule along the interconnect. For example, the distance between cache molecule 122 and core 104 may be less than the distance between cache molecule 126 and core 104, which in turn may be less than the distance between cache molecule 128 and core 104. In other embodiments, other forms of interconnect may be used, such as a single ring interconnect, a linear interconnect, or a grid interconnect. In each case, a distance metric may be defined to describe the latency ordering of cache molecules with respect to a particular core.

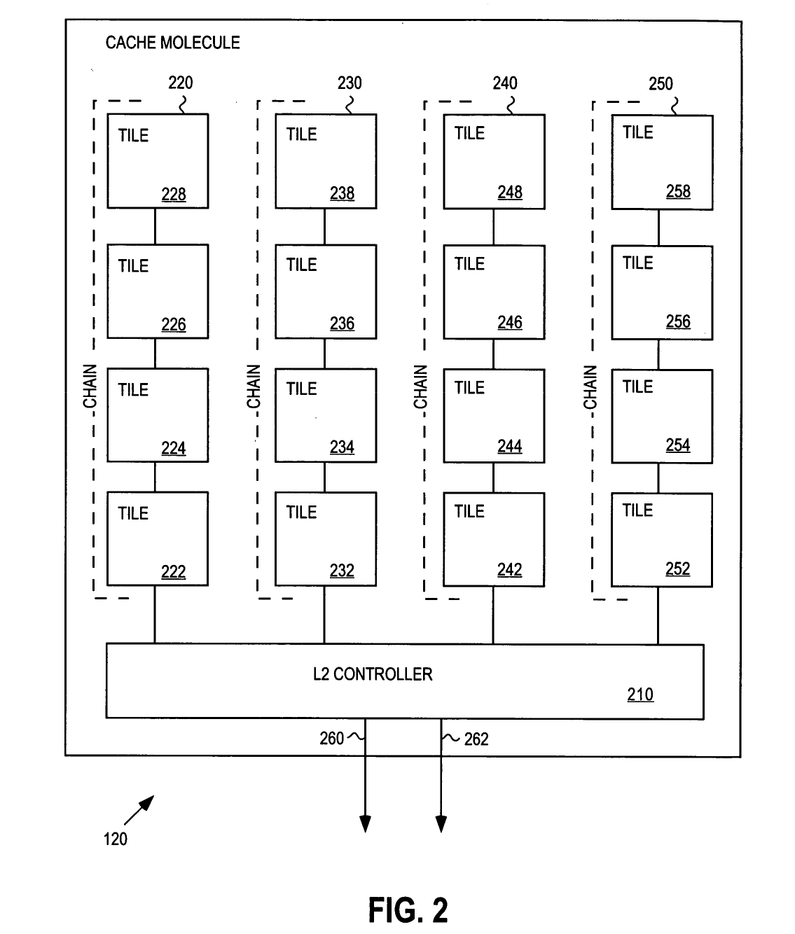

Referring now to FIG. 2, a diagram of a cache molecule is shown, according to one embodiment of the present disclosure. In one embodiment, the cache molecule may be the cache molecule 120 of FIG. 1. Cache molecule 120 may include an L2 controller 210 and one or more cache chains. L2 controller 210 may have one or more connections 260, 262 for connecting with the interconnect. In the FIG. 2 embodiment, four cache chains 220, 230, 240, 250 are shown, but there could be more than or fewer than four cache chains in a cache molecule. In one embodiment, any particular cache line in memory may be mapped to a single one of the four cache chains. When accessing a particular cache line in cache molecule 120, only the corresponding cache chain may need be searched and accessed. Cache chains may therefore be analogized to sets in a traditional set-associative cache: however, because of the number of interconnections present in a cache of the present disclosure, there may generally be fewer cache chains than sets in a traditional set-associative cache of similar cache size. In other embodiments, any particular cache line in memory may be mapped to two or more cache chains within a cache molecule.

Each cache chain may include one or more cache tiles. For example, cache chain 220 is shown with cache tiles 222-228. In other embodiments, there could be more than or fewer than four cache tiles in a cache chain. In one embodiment, the cache tiles of a cache chain are not address partitioned, e.g. a cache line loaded into a cache chain may be placed into any of that cache chain's cache tiles. Due to the differing interconnect lengths along a cache chain, the cache tiles may vary in access latency along a single cache chain. For example, the access latency from cache tile 222 may be less than the access latency from cache tile 228. Thus there may be a metric of “distance” along a cache chain may be used to describe a latency ordering of cache tiles with respect to a particular cache chain. In one embodiment, each cache tile in a particular cache chain may be searched in parallel with the other cache tiles in the cache chain.

When a core requests a particular cache line, and the requested cache line is determined to be not resident in the cache (a “cache miss”), that cache line may be brought into the cache from a cache closer to memory in the cache hierarchy, or from memory. In one embodiment, it may be possible to initially place that new cache line close to the requesting core. However, in some embodiments, it may be advantageous to initially place the new cache line at some distance from the requesting core, and later move that cache line closer to the requesting core when it is repeatedly accessed.

In one embodiment, the new cache line may simply be placed in a cache tile at greatest distance from the requesting processor core. However, in another embodiment, each cache tile may return a score which may indicate capacity, appropriateness, or other metric of willingness to allocate a location to receive a new cache line subsequent to a cache miss. Such a score may reflect such information as the physical location of the cache tile and how recently the potential victim cache line was accessed. When a cache molecule reports a miss to a requested cache line, it may return the largest score reported by the cache tiles within. Once a miss to the entire cache is determined, the cache may compare the molecule largest scores and select the molecule with the overall largest score to receive the new cache line.

In another embodiment, the cache may determine which cache line was least recently used (LRU), and select that cache line for eviction in favor of a new cache line subsequent to a miss. Since the determination of LRU may be complicated to implement, in another embodiment a pseudo-LRU replacement method may be used. LRU counters may be associated with each location in each cache tile in the overall cache. On a cache hit, each location in each cache tile that may contain the requested cache line but did not may be accessed and have that location's LRU counter incremented. When subsequently another requested cache line is found in a particular location in a particular cache tile, that location's LRU counter may be reset. In this manner the locations' LRU counters may contain values correlated to how frequently the cache lines of that location in each cache tile are accessed. In this embodiment, the cache may determine the highest LRU counter value within each cache tile, and then select the cache tile with the overall highest LRU counter value to receive the new cache line.

Enhancements to any of these placement methods may include the use of criticality hints for the cache lines in memory. When a cache line contains data loaded by an instruction with a criticality hint, that cache line may not be selected for eviction until some releasing event, such as the need for forward progress, occurs.

Once a particular cache line is located within the overall cache, it may be advantageous to move it closer to a core that frequently requests it. In some embodiments, there may be two kinds of cache line moves supported. A first kind of move may be inter-molecule, where cache lines may move between cache molecules along the interconnect. The second kind of move may be intra-molecule, where cache lines may move between cache tiles along the cache chains.

We will first discuss the inter-molecule moves. In one embodiment, the cache lines could be moved closer to a requesting core whenever they are accessed by that requesting core. However, in another embodiment it may be advantageous to delay any moves until the cache line has been accessed a number of times by a particular requesting core. In one such embodiment, each cache line of each cache tile may have an associated saturating counter that saturates after a predetermined count value. Each cache line may also have additional bits and associated logic to determine from which direction along the interconnect the recent requesting core is located. In other embodiments, other forms of logic may be used to determine the amount or frequency of requests and the location or identity of the requesting core. These other forms of logic may particularly be used in embodiments where the interconnect is not a dual ring interconnect, but a single ring interconnect, a linear interconnect, or a grid interconnect.

Referring again to FIG. 1, as an example let core 110 be a requesting core, and let the requested cache line be initially placed into cache molecule 134. Access requests from core 110 will be noted as being from the counter-clockwise direction by the additional bits and logic associated with the requested cache line in cache molecule 134. After the occurrence of the number of accesses that are required to cause the saturating counter of the requested cache line to saturate at its predetermined value, the requested cache line may be moved in the counterclockwise direction towards core 110. In one embodiment, it may be moved one cache molecule over to cache molecule 132. In other embodiments, it may be moved over more than one molecule at a time. Once within cache molecule 132, the requested cache line will be associated with a new saturating counter reset to zero. If core 110 continues to access that requested cache line, it may be moved again in the direction of core 110. If, on the other hand, it begins to be repeatedly accessed by another core, say core 104, it may be moved back in the clockwise direction to be closer to core 104.

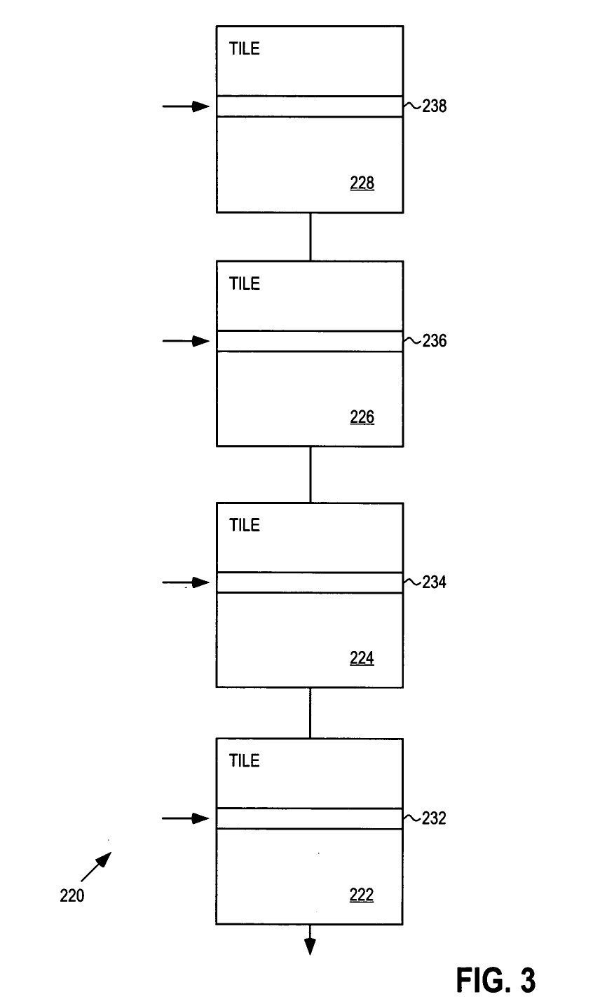

Referring now to FIG. 3, a diagram of cache tiles in a cache chain is shown, according to one embodiment of the present disclosure. In one embodiment the cache tiles 222-228 may be the cache tiles of cache molecule 120 of FIG. 2, which is shown as being the corresponding closest cache molecule to core 102 of FIG. 1.

We will now discuss the intra-molecule moves. In one embodiment, intra-molecule moves in a particular cache molecule may be made only in response to requests from the corresponding “closest” core (e.g. the core with smallest distance metric to said molecule). In other embodiments, intra-molecule moves may be permitted in response to requests from other, more remote, cores. As an example, let corresponding closest core 102 repeatedly request access to the cache line initially at location 238 of cache tile 228. In this example, the associated bits and logic of location 238 may indicate that the requests come from the closest core 110, and not from a core either from the clockwise or counterclockwise direction. After the occurrence of the number of accesses that are required to cause the saturating counter of the requested cache line at location 238 to saturate at its predetermined value, the requested cache line may be moved in the direction towards core 110. In one embodiment, it may be moved one cache tile closer to location 236 in cache tile 226. In other embodiments, it may be moved closer more than one cache tile at a time. Once within cache tile 226, the requested cache line in location 236 will be associated with a new saturating counter reset to zero.

In either the case of inter-molecule moves or the case of intra-molecule moves, a destination location in the targeted cache molecule or targeted cache tile, respectively, may need to be selected and prepared to receive the moved cache line. In several embodiments, the destination location may be selected and prepared using a traditional cache victim method, by causing a “bubble” to propagate from cache tile to cache tile, or from cache molecule to cache molecule, or by swapping the cache line with another cache line in the destination structure (molecule or tile). In one embodiment, the saturating counter and associated bits and logic of the cache lines in the destination structure may be examined to determine if a swapping candidate cache line exists that is nearing a move determination back in the direction of the cache line that is desired to be moved. If so, then these two cache lines may be swapped, and they may both move advantageously towards their respective requesting cores. In another embodiment, the pseudo-LRU counters may be examined to help determine a destination location.

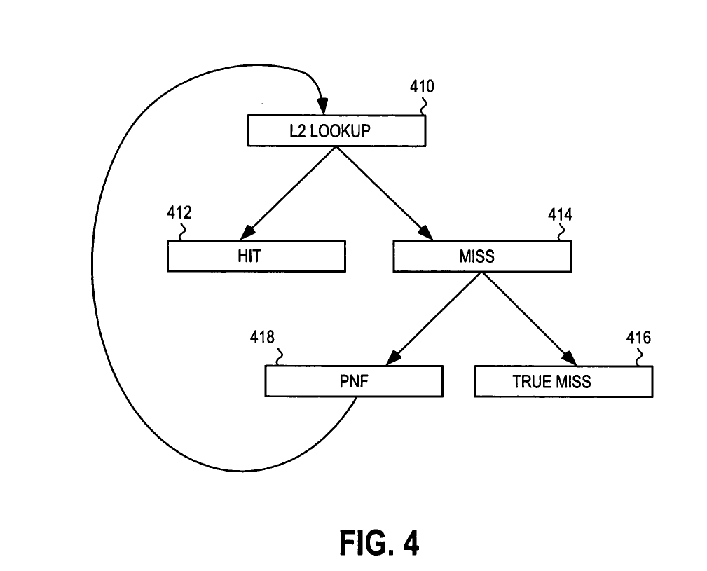

Referring now to FIG. 4, a diagram of searching for a cache line is shown, according to one embodiment of the present disclosure. Searching for a cache line in a distributed cache, such as the L2 cache shown in FIG. 1, may first require that a determination be made whether the requested cache line is present (a “hit”) or is not present (a “miss”) in the cache. In one embodiment, a lookup request from a core is made to the corresponding “closest” cache molecule. If a hit is found, the process may end. However, if a miss is found in that cache molecule, then a lookup request is sent to the other cache molecules. Each of the other cache molecules may then determine whether they have the requested cache line, and report back a hit or a miss. This two-part lookup may be represented by block 410. If a hit is determined in one or more cache molecules, the process completes at block 412. In other embodiments, searching for a cache line may begin by searching one or more cache molecules or cache tiles that are closest to the requesting processor core. If the cache line is not found there, then the search may proceed to search other cache molecules or cache tiles either in order of distance from the requesting processor core or in parallel.

However, if all the cache molecules report a miss, at block 414, the process is not necessarily finished. Due to the technique of moving the cache lines as discussed above, it is possible that the requested cache line was moved out of a first cache molecule which subsequently reported a miss, and moved into a second cache molecule that previously reported a miss. In this situation, all of the cache molecules may report a miss to the requested cache line, and yet the requested cache line is actually present in the cache. The status of a cache line in such a situation may be called “present but not found” (PNF). In block 414, a further determination may be made to find whether the misses reported by the cache molecules is a true miss (process completes at block 416) or is a PNF. In the case a PNF is determined, in block 418, the process may in some embodiments need to repeat until the requested cache line is found between moves.

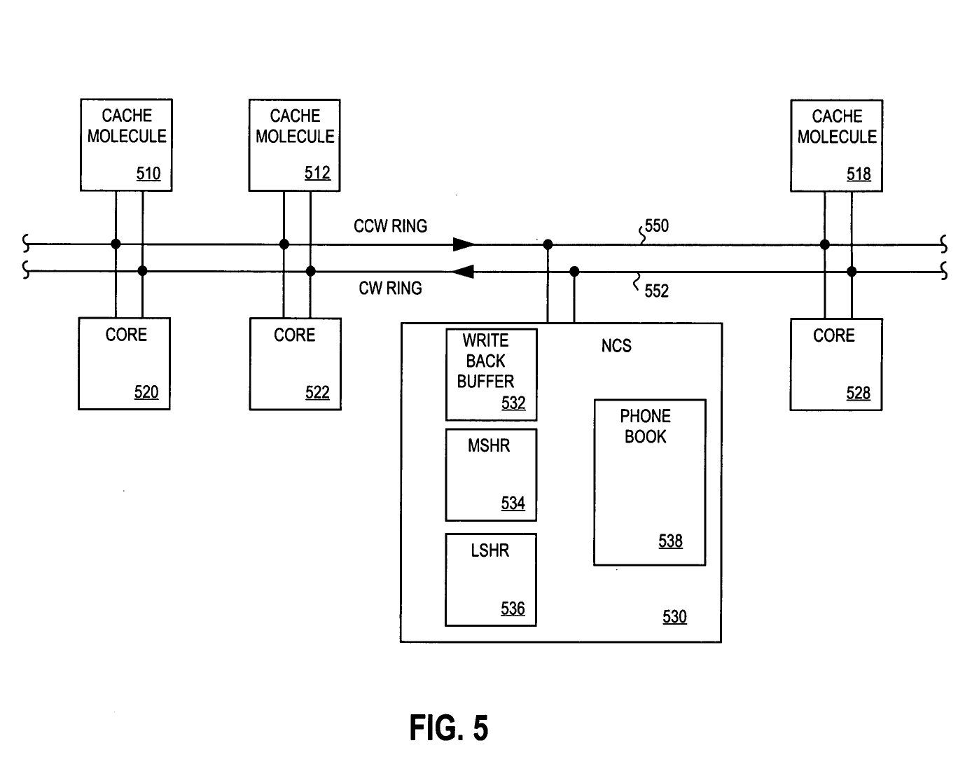

Referring now to FIG. 5, a diagram of a non-uniform cache architecture collection service is shown, according to one embodiment of the present disclosure. In one embodiment, a number of cache molecules 510-518 and processor cores 520-528 may be interconnected with a dual ring interconnect, having a clockwise ring 552 and a counter-clockwise ring 550. In other embodiments, other distributions of cache molecules and cores may be used, and other interconnects may be used.

In order to search the cache and support the determination of whether a reported miss is a true miss or a PNF, in one embodiment a non-uniform-cache collection service (NCS) 530 module may be used. The NCS 530 may include a write-back buffer 532 to support evictions from the cache, and may also have a miss status holding register (MSHR) 534 to support multiple requests to the same cache line declared as a miss. In one embodiment, write-back buffer 532 and MSHR 534 may be of traditional design.

Lookup status holding register (LSHR) 536 may in one embodiment be used to track the status of pending memory requests. The LSHR 536 may receive and tabulate hit or miss reports from the various cache molecules responsive to the access requests for the cache lines. In cases where LSHR 536 has received miss reports from all of the cache molecules, it may not be clear whether a true miss or a PNF has occurred.

Therefore, in one embodiment, NCS 530 may also include a phonebook 538 to differentiate between cases of a true miss and cases of a PNF. In other embodiments, other logic and methods may be used to make such a differentiation. Phonebook 538 may include an entry for each cache line present in the overall cache. When a cache line is brought into the cache, a corresponding entry is entered into the phonebook 538. When the cache line is removed from the cache, the corresponding phonebook entry may be invalidated or otherwise de-allocated. In one embodiment the entry may be the cache tag of the cache line, but in other embodiments other forms of identifiers for the cache lines could be used. The NCS 530 may include logic to support searches of the phonebook 538 for any requested cache line. In one embodiment, phonebook 538 may be a content-addressable memory (CAM).

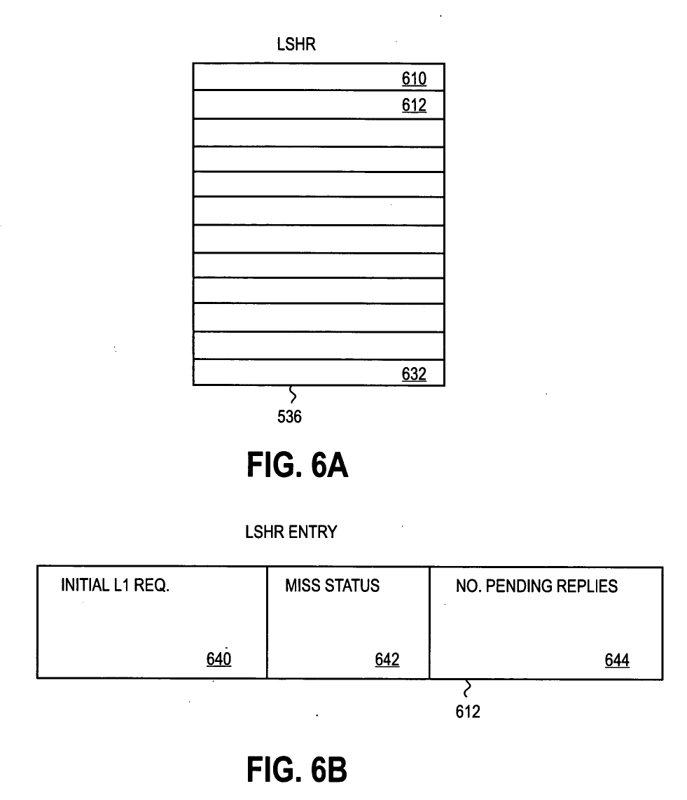

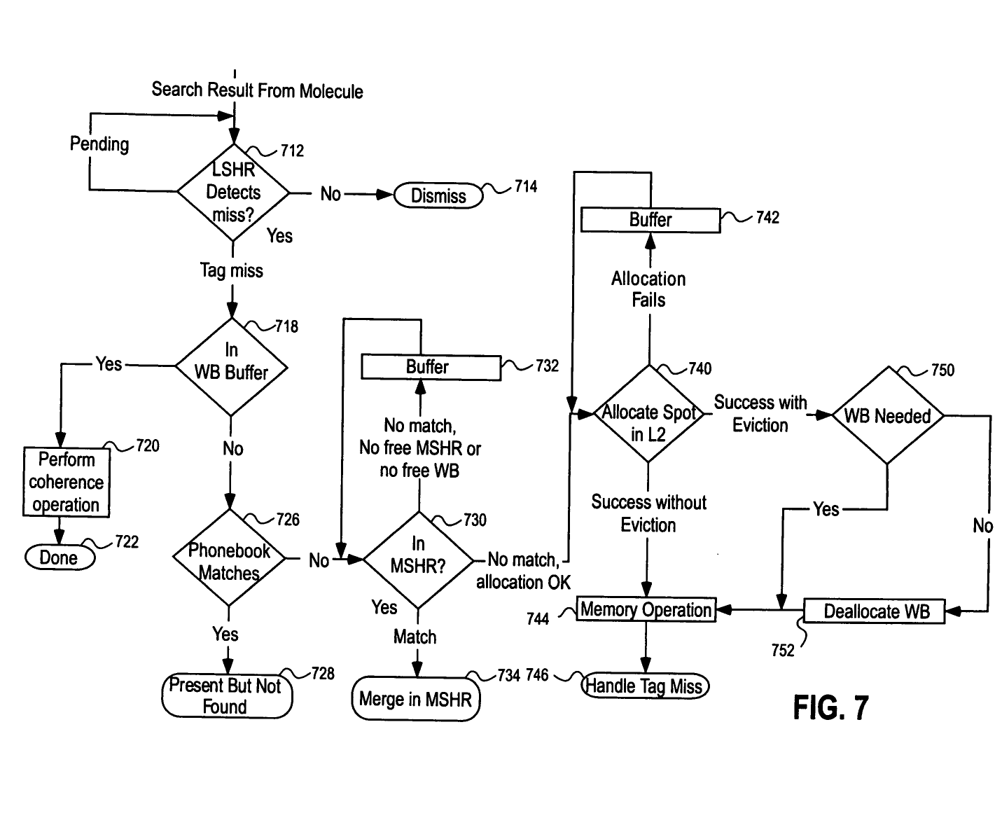

Referring now to FIG. 6A, a diagram of a lookup status holding register (LSHR) is shown, according to one embodiment of the present disclosure. In one embodiment, the LSHR may be LSHR 536 of FIG. 5. The LSHR 536 may include numerous entries 610-632, where each entry may represent a pending request for a cache line. In varying embodiments these entries 610-632 may include fields to describe the requested cache lines and the hit or miss reports received from the various cache molecules. When the LSHR 536 receives a hit report from any cache molecule, the NCS 530 may then de-allocate the corresponding entry in the LSHR 536. When the LSHR 536 has received a miss report from all of the cache molecules for a particular requested cache line, the NCS 530 may then invoke logic to make the determination whether a true miss has occurred, or if this is a case of PNF.

Referring now to FIG. 6B, a diagram of a lookup status holding register entry is shown, according to one embodiment of the present disclosure. In one embodiment, the entry may include an indication of the original lower-level cache request (here from level one L1 cache, “initial L1 request”) 640, a miss status bit 642 which may start set to “miss” but may be toggled to “hit” when any cache molecule reports a hit to that cache line, and a count-down field showing a number of pending replies 644. In one embodiment the initial L1 request may include the cache tag of the requested cache line. The number of pending replies 644 field may be initially set to the total number of cache molecules. When each report for the requested cache line in initial L1 request 640 is received, the number of pending replies 644 may be decremented. When the number of pending replies 644 reaches zero, the NCS 530 may then examine the miss status bit 642. If the miss status bit 642 remains miss, then the NCS 530 may examine the phonebook to determine whether this is a true miss or a PNF.

Referring now to FIG. 7, a flowchart of a method for searching for a cache line is shown, according to one embodiment of the present disclosure. In other embodiments, the individual portions of the process shown by the blocks of FIG. 7 may be re-allocated and re-arranged in time while still performing the process. In one embodiment, the FIG. 7 method may be performed by NCS 530 of FIG. 5.

Beginning in decision block 712, a hit or miss report is received from a cache molecule. If the report is a hit, then the process exits along the NO path and the search terminates in block 714. If the report is a miss and there are still pending reports, then the process may exit along the PENDING path and reenter decision block 712. If, however, the report is a miss and there are no further pending reports, the process exits along the YES path.

Then in decision block 718 it may be determined whether the missing cache line has an entry in the write-back buffer. If so, then the process exits along the YES path, and in block 720 the cache line request may be satisfied by the entry in the write-back buffer as part of a cache coherency operation. The search may then terminate in block 722. If, however, the missing cache line has no entry in the write-back buffer, then the process exits along the NO path.

In decision block 726 a phonebook containing tags of all cache lines present in the cache may be searched. If a match is found in the phonebook, then the process exits along the YES path and in block 728 the condition of present but not found may be declared. If, however, no match is found, the process exits along the NO path. Then in decision block 730 it may be determined whether another pending request to the same cache line exists. This may be performed by examining a miss status holding register (MSHR), such as MSHR 534 of FIG. 5. If so, then the process exits along the YES branch and the search is concatenated with the existing search in block 734. If there is no pre-existing request and there are resource limitations, such as the MSHR or write-back buffer being temporarily full, then the process places the request in a buffer 732 and may re-enter decision block 730. However, if there is no pre-existing request and there are no resource limitations, the process may then enter decision block 740.

In decision block 740 it may be determined how best to allocate a location to receive the requested cache line in the cache. If for any reason an allocation may not presently be made, the process may place the request in a buffer 742 and try again later. If an allocation may be made without forcing an eviction, such as to a location containing a cache line in an invalid state, the process exits and enters block 744 where a request to memory may be performed. If an allocation may be made by forcing an eviction, such as to a location containing a cache line in a valid state that has been infrequently accessed, the process exits and enters decision block 750. In decision block 750 it may be determined whether a write-back of the contents of the victimized cache line is required. If not, then in block 752 the entry in the write-back buffer set aside for the victim may be de-allocated prior to initiating the request to memory in block 744. If so, then the request to memory in block 744 may also include the corresponding write-back operation. In any case, the memory operation of block 744 ends with a clean up of any tag misses in block 746.

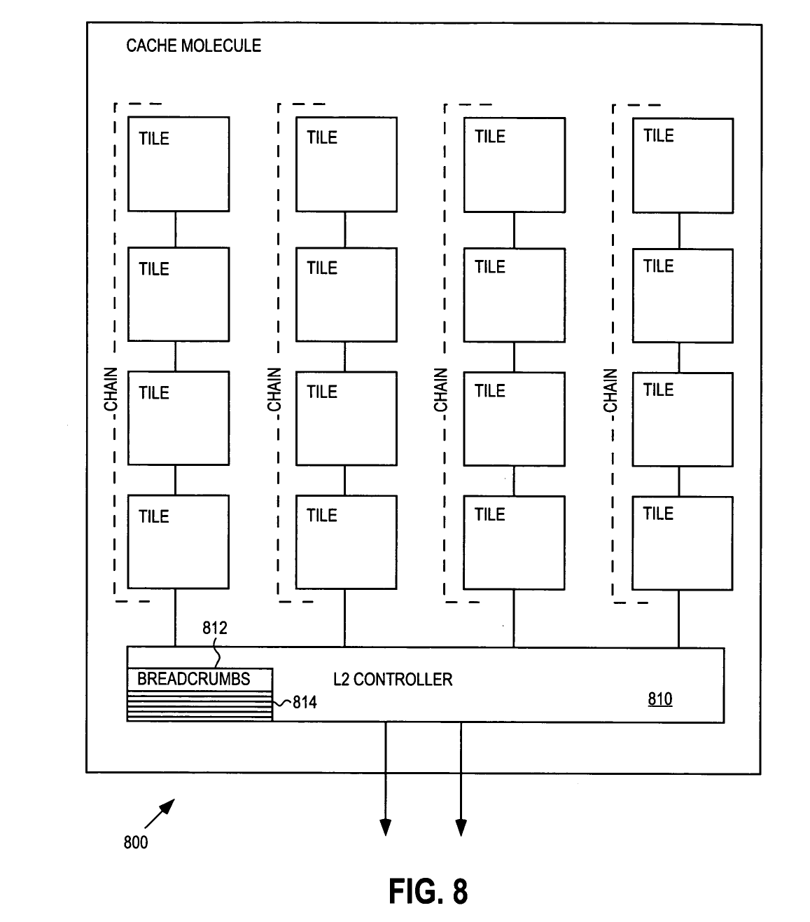

Referring now to FIG. 8, a diagram of a cache molecule with breadcrumb table is shown, according to one embodiment of the present disclosure. The L2 controller 810 of cache molecule 800 has added a breadcrumbs table 812. In one embodiment, whenever L2 controller 810 receives a request for a cache line, the L2 controller may insert that cache line's tag (or other identifier) into an entry 814 of the breadcrumbs table 812. The entry in the breadcrumbs table may be retained until such time as the pending search for the requested cache line is completed. The entry may then be de-allocated.

When another cache molecule wishes to move a cache line into cache molecule 800, the L2 controller 810 may first check to see if the move candidate cache line has its tag in the breadcrumbs table 812. If, for example, the move candidate cache line is the requested cache line whose tag is in entry 814, then L2 controller 810 may refuse to accept the move candidate cache line. This refusal may persist until the pending search for the requested cache line is completed. The search may only be completed after all cache molecules submit their individual hit or miss reports. This may mean that the forwarding cache molecule has to keep the requested cache line until sometime after it submits its hit or miss report. In this situation, the hit or miss report from the forwarding cache molecule would indicate a hit, rather than a miss. In this manner, the use of the breadcrumbs table 812 may inhibit the occurrence of present but not found cache lines.

When used in connection with cache molecules containing breadcrumbs tables, the NCS 530 of FIG. 5 could be modified to delete the phonebook. Then, when the LSHR 536 received all miss reports from the cache molecules, NCS 530 could declare a true miss and the search could be considered completed.

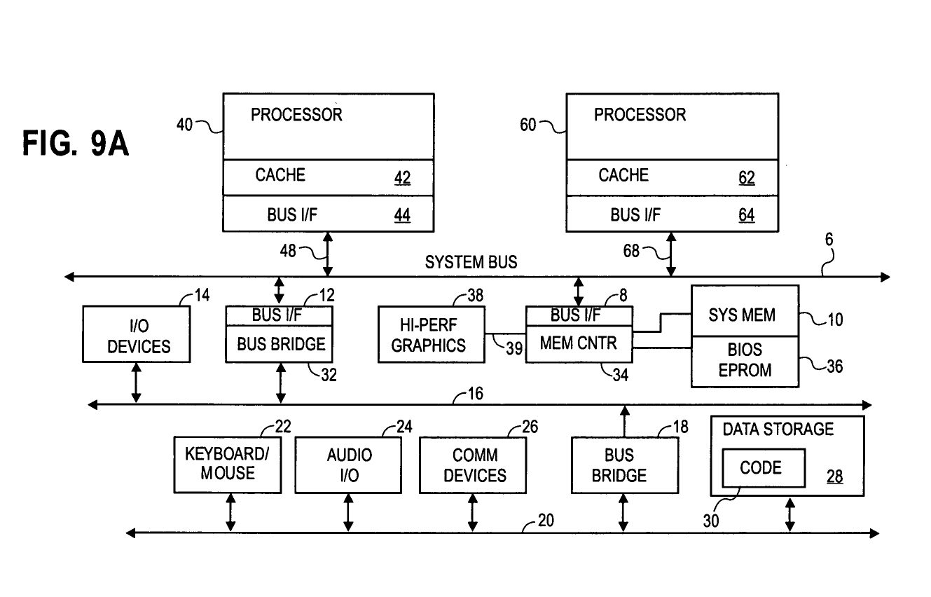

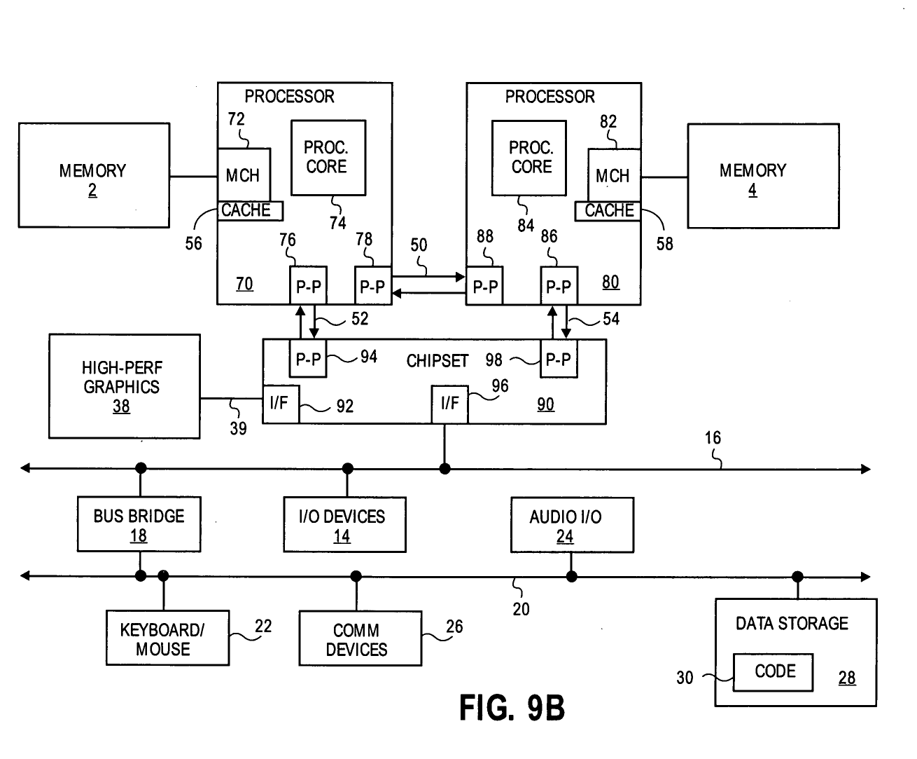

Referring now to FIGS. 9A and 9B, schematic diagrams of systems with processors with multiple cores and cache molecules are shown, according to two embodiments of the present disclosure. The FIG. 9A system generally shows a system where processors, memory, input/output devices are interconnected by a system bus, whereas the FIG. 9B system generally shows a system where processors, memory, and input/output devices are interconnected by a number of point-to-point interfaces.

The FIG. 9A system may include one or several processors, of which only two, processors 40, 60 are here shown for clarity. Processors 40, 60 may include level two caches 42, 62, where each processor 40, 60 may include multiple cores and each cache 42, 62 may include multiple cache molecules. The FIG. 9A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other busses may be used. In some embodiments memory controller 34 and bus bridge 32 may collectively be referred to as a chipset. In some embodiments, functions of a chipset may be divided among physical chips differently than as shown in the FIG. 9A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory, and may include other basic operational firmware instead of BIOS. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct data from system memory 10 to the high-performance graphics circuit 38 across high-performance graphics interface 39.

The FIG. 9B system may also include one or several processors, of which only two, processors 70, 80 are shown for clarity. Processors 70, 80 may include level two caches 56, 58, where each processor 70, 80 may include multiple cores and each cache 56, 58 may include multiple cache molecules. Processors 70, 80 may each include a local memory controller hub (MCH) 72, 82 to connect with memory 2, 4. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. In other embodiments, chipset functions may be implemented within the processors 70, 80. Chipset 90 may also exchange data with a high-performance graphics circuit 38 via a high-performance graphics interface 92.

In the FIG. 9A system, bus bridge 32 may permit data exchanges between system bus 6 and bus 16, which may in some embodiments be a industry standard architecture (ISA) bus or a peripheral component interconnect (PCI) bus. In the FIG. 9B system, chipset 90 may exchange data with a bus 16 via a bus interface 96. In either system, there may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A processor, comprising:
a set of processor cores coupled via an interface; and
a set of cache tiles that may be searched in parallel, where a first cache tile and a second cache tile of said set is to receive a first cache line, and where a distance from a first core of said set of processor cores to said first cache tile and said second cache tile is different.

2. The processor of claim 1, wherein said interface is a ring.

3. The processor of claim 2, wherein said ring includes a clockwise ring and a counter-clockwise ring.

4. The processor of claim 1, wherein said interface is a grid.

5. The processor of claim 1, wherein each of a first subset of said set of cache tiles is coupled to one of said set of processor cores and is associated with a first cache chain of said one of said set of processor cores, and each of a second subset of said set of cache tiles is coupled to said one of said set of processor cores and is associated with a second cache chain of said one of said set of processor cores.

6. The processor of claim 5, wherein each of said first cache chain of said one of said set of processor cores and each of said second cache chain of said one of said set of processor cores are associated with a cache molecule of said one of said set of processor cores.

7. The processor of claim 6, wherein a first cache line requested by a first processor core of said set of processor cores is to be placed in a first cache tile in a first cache molecule that is not coupled to said first processor core.

8. The processor of claim 7, wherein each cache tile is to indicate a score for placing a new cache line, and each cache molecule is to indicate a molecule largest score selected from said scores of said cache tiles.

9. The processor of claim 8, wherein said first cache line to be placed responsive to an overall largest score of said molecule largest scores.

10. The processor of claim 7, wherein said first cache line to be placed responsive to a software criticality hint.

11. The processor of claim 7, wherein said first cache line in said first cache tile of a first cache chain is to be moved to a second cache tile of said first cache chain when said first cache line is accessed a number of times.

12. The processor of claim 11, wherein said first cache line is to be moved to a location of an evicted cache line.

13. The processor of claim 11, wherein said first cache line is to be swapped with a second cache line of said second cache tile.

14. The processor of claim 7, wherein said first cache line in said first cache molecule is to be moved to a second cache molecule when said first cache line is accessed a number of times.

15. The processor of claim 14, wherein said first cache line is to be moved to a location of an evicted cache line.

16. The processor of claim 14, wherein said first cache line is to be swapped with a second cache line of said second cache molecule.

17. The processor of claim 7, wherein a lookup request for said first cache line in said first cache molecule is to be sent to all cache tiles of said first cache chain in parallel.

18. The processor of claim 7, wherein a lookup request for said first cache line is to be sent to said cache molecules in parallel.

19. The processor of claim 18, wherein each of said cache molecules is to return a hit or miss message to a first table.

20. The processor of claim 19, wherein when said first table determines that all of said hit or miss messages indicate misses, then a search is to be made to a second table of tags of cache lines present.

21. The processor of claim 20, wherein when a first tag of said first cache line is found in said second table, then said first cache line is to be determined to be present but not found.

22. The processor of claim 18, wherein a first one of said cache molecules is to refuse to accept a transfer of said first cache line after receiving said lookup request.

23. A method, comprising:
searching for a first cache line in cache tiles associated with a first processor core;
if said first cache line is not found in said cache tiles associated with said first processor core, then sending a request for said first cache line to sets of cache tiles associated with processor cores other than said first processor core; and
tracking responses from said sets of cache tiles using a register.

24. The method of claim 23, wherein said tracking includes counting down the expected number of said responses.

25. The method of claim 24, wherein said first cache line may move from a first cache tile to a second cache tile.

26. The method of claim 25, further comprising declaring said first cache line not found in said tiles after all said responses are received.

27. The method of claim 26, further comprising when said first cache line not found in said tiles, searching a directory of cache lines present to determine whether said first cache line is present but not found.

28. The method of claim 23, further comprising preventing moving said first cache line into said second cache tile after a response from said second cache tile has been issued by examining a marker.

29. A method, comprising:
placing a first cache line in a first cache tile; and
moving said first cache line to a second cache tile closer to a requesting processor core.

30. The method of claim 29, further comprising counting a number of requests for said first cache line from said requesting processor core before said moving.

31. The method of claim 29, further comprising tracking a direction of a request for said first cache line from said requesting processor core to permit moving in said direction.

32. The method of claim 29, wherein said moving includes moving between a first cache molecule holding said first cache tile to a second cache molecule holding said second tile.

33. The method of claim 29, wherein said moving includes moving within a first cache molecule coupled to said requesting processor core holding said first cache tile and said second cache tile.

34. The method of claim 29, wherein said moving includes evicting a second cache line in said second cache tile.

35. The method of claim 29, wherein said moving includes swapping said first cache line in said first cache tile with a second cache line in said second cache tile.

36. A system, comprising:
a processor including a set of processor cores coupled via an interface, and a set of cache tiles that may be searched in parallel, where a first cache tile and a second cache tile of said set is to receive a first cache line, and where a distance from a first core of said set of processor cores to said first cache tile and said second cache tile is different;
a system interface to couple said processor to input/output devices; and
a network controller to receive signals from said processor.

37. The system of claim 36, wherein each of a first subset of said set of cache tiles is coupled to one of said set of processor cores and is associated with a first cache chain of said one of said set of processor cores, and each of a second subset of said set of cache tiles is coupled to said one of said set of processor cores and is associated with a second cache chain of said one of said set of processor cores.

38. The system of claim 37, wherein each of said first cache chain of said one of said set of processor cores and each of said second cache chain of said one of said set of processor cores are associated with a cache molecule of said one of said set of processor cores.

39. The system of claim 38, wherein a first cache line requested by a first processor core of said set of processor cores is to be placed in a first cache tile in a first cache molecule that is not coupled to said first processor core.

40. The system of claim 39, wherein a first cache line in a first cache tile of a first cache chain is to be moved to a second cache tile of said first cache chain when said first cache line is accessed a number of times.

41. The system of claim 39, wherein said first cache line is to be moved to a location of an evicted cache line.

42. The system of claim 39, wherein said first cache line is to be swapped with a second cache line of said second cache tile.

43. The system of claim 39, wherein said first cache line in said first cache molecule is to be moved to a second cache molecule when said first cache line is accessed a number of times.

44. The system of claim 39, wherein a lookup request for said first cache line in said first cache molecule is to be sent to all cache tiles of said first cache chain in parallel.

45. The system of claim 39, wherein a lookup request for said first cache line is to be sent to said cache molecules in parallel.

46. An apparatus, comprising:
means for searching for a first cache line in cache tiles associated with a first processor core;
means for, if said first cache line is not found in said cache tiles associated with said first processor core, then sending a request for said first cache line to a set of processor cores; and
means for tracking responses from said set of processor cores using a register.

47. The apparatus of claim 46, wherein said means for tracking includes means for counting down the expected number of said responses.

48. The apparatus of claim 47, wherein said first cache line may move from a first cache tile to a second cache tile.

49. The apparatus of claim 48, further comprising means for declaring said first cache line not found in said tiles after all said responses are received.

50. The apparatus of claim 49, further comprising means for, when said first cache line not found in said tiles, searching a directory of cache lines present to determine whether said first cache line is present but not found.

51. The apparatus of claim 48, further comprising means for preventing moving said first cache line into said second cache tile after a response from said second cache tile has been issued by examining a marker.

52. An apparatus, comprising:
means for placing a first cache line in a first cache tile; and
means for moving said first cache line to a second cache tile closer to a requesting processor core.

53. The apparatus of claim 52, further comprising means for counting a number of requests for said first cache line from said requesting processor core before said moving.

54. The apparatus of claim 52, further comprising means for tracking a direction of a request for said first cache line from said requesting processor core to permit moving in said direction.

55. The apparatus of claim 52, wherein said means for moving includes means for moving between a first cache molecule holding said first cache tile to a second cache molecule holding said second tile.

56. The apparatus of claim 52, wherein said means for moving includes means for moving within a first cache molecule coupled to said requesting processor core holding said first cache tile and said second cache tile.

57. The apparatus of claim 56, wherein said means for moving includes means for evicting a second cache line in said second cache tile.

58. The apparatus of claim 56, wherein said means for moving includes means for swapping said first cache line in said first cache tile with a second cache line in said second cache tile.
